(19) United States
(12) Patent Application Publication
(10) Pub. No.: US 2016/0368357 A1
(43) Pub. Date: Dec. 22, 2016

(54) APPARATUS AND METHODS FOR VEHICLE FLOOD PREVENTION

(71) Applicants: Kenneth Lerner, Smithtown, NY (US); Matthew Crook, Wilmington, NC (US)

(72) Inventors: Kenneth Lerner, Smithtown, NY (US); Matthew Crook, Wilmington, NC (US)

(21) Appl. No.: 15/153,864

(22) Filed: May 13, 2016

Related U.S. Application Data
(60) Provisional application No. 62/180,943, filed on Jun. 17, 2015.

(51) Int. Cl. B60J 11/04; B65D 33/25; B65D 85/68; B65B 7/02

(52) U.S. Cl. CPC B60J 11/04; B65B 7/02; B65D 33/25; B65D 85/68; B65D 2585/6867

(57) ABSTRACT

A method of protecting a vehicle from flood damage is disclosed that includes placing a flood protection bag having an open end and a closed end on a surface, opening the open end of the flood protection bag to form an opening at the open end of the flood protection bag and to define a cavity within the flood protection bag; advancing the vehicle through the opening and into the cavity of the flood protection bag; and sealing the opening in the open end of the flood protection bag to enclose the vehicle within the flood protection bag.

### CROSS-REFERENCE TO RELATED APPLICATION

This application claims the benefit of and priority to U.S. Provisional Application Ser. No. 62/180,943 filed on Jun. 17, 2015 which is incorporated herein in its entirety by reference.

### BACKGROUND

### 1. Technical Field

The present disclosure relates to vehicle flood protection and, more particularly, to apparatus and methods for vehicle flood prevention.

### 2. Background of Related Art

The average annual flood loss in the United States over the past 10 years is estimated to exceed $2.9 billion. In addition to permanent structures, vehicles are particularly susceptible to damage caused by flooding and account for a large amount of flood loss each year in the United States. As little as six inches of water is capable of causing significant damage to vehicles.

Car covers and flood protection systems are generally known. However, there is a continuing need for a simplified yet effective vehicle flood prevention apparatus and method that is fully portable, easily stored when not in use, and readily facilitates assembly and disassembly without the need for specialized training or skills, complex instructions, additional tools or equipment, etc.

### SUMMARY

In accordance with the present disclosure, apparatus and methods for vehicle flood prevention are provided. The apparatus generally includes a vehicle flood protection bag and one or more securement members for sealing an open end of the flood protection bag. In embodiments, the apparatus may also include a pair of cables that together cooperate to fully enclose and seal a vehicle within the flood protection bag so as to protect the vehicle against flood damage.

The method of assembly generally includes: unrolling, unfolding, spreading, and/or otherwise manipulating the bag such that the flood protection bag is situated flat on a surface; prepping and aligning the vehicle in relation to an open end of the flood protection bag; positioning the open end of the bag to establish a sufficiently large mouth capable of accepting the vehicle; advancing the vehicle into the open end of the bag until the vehicle is fully disposed within the bag; allowing a driver to exit the vehicle and exit the bag; and sealing the open end of the flood protection bag to enclose the vehicle within the flood protection bag. In embodiments, sealing the open end of the flood protection bag includes using a zipper to seal the open end of the bag. In other embodiments, sealing the open end of the flood protection bag includes attaching first and second securement members to the corners of a closed end of the flood protection bag opposite the open end of the flood protection bag; folding, rolling, tucking, and/or otherwise manipulating the open end of the bag to close the open end and/or reduce slack in the bag; and attaching third and fourth securement members to the corners of the open end of the bag. In embodiments, the method also includes securing, e.g., tying off, first and second cables between the first and third and second and fourth securement members, respectively, such that the cables define a crossed or “X”-shaped configuration atop the vehicle. As can be appreciated, in order to disassemble the system and remove the vehicle, the reverse method is affected.

In one aspect of the disclosure, a method of protecting a vehicle from flood damage includes placing a flood protection bag having an open end and a closed end on a surface; aligning the vehicle with the open end of the flood protection bag; opening the open end of the flood protection bag to form an opening and to define a cavity within the flood protection bag; advancing the vehicle through the opening of the flood protection bag into the cavity of the flood protection bag; and sealing the opening in the open end of the flood protection bag to enclose the vehicle within the flood protection bag.

In embodiments, sealing the open end of the flood protection bag includes using a zipper positioned about the opening in the flood protection bag to seal the opening.

In some embodiments, sealing the open end of the flood protection bag includes attaching securement members to edges of the flood protection bag defining the opening.

In certain embodiments, the method further includes attaching securement members to corners of the open and closed ends of the flood protection bag and connecting first and second cables diagonally between the securement members on the closed end of the flood protection bag and the securement members on the open end of the bag.

In embodiments, the method includes folding or rolling the open end of the bag to remove slack from the open end of the bag prior to attaching the securement members to the corners of the open end of the flood protection bag.

In certain embodiments, the method further includes prepping the vehicle prior to advancing the vehicle into the cavity of the flood protection bag.

In embodiments, prepping the vehicle includes removing an antenna from the vehicle.

In some embodiments, the flood protection bag is dimensioned to allow a driver to exit the vehicle and the flood protection bag when the vehicle is positioned within the flood protection bag.

In embodiments, sealing the open end of the flood protection bag includes inserting a rope through grommets positioned along edges of the flood protection bag defining the opening.

In embodiments, the method includes connecting first and second cables diagonally between grommets positioned on corners of the open and closed ends of the flood protection bag to raise a height of the open end of the flood protection bag.

### BRIEF DESCRIPTION OF THE DRAWINGS

Various embodiments of the presently disclosed vehicle flood prevention apparatus are described with reference to the accompanying drawings, wherein:

FIG. 1 is a perspective view of the vehicle flood protection bag of the vehicle flood prevention apparatus of the present disclosure illustrated in a storage state;

FIG. 2 is a perspective view of the vehicle flood protection bag illustrated in a folded, unrolled state;

FIG. 3 is a perspective view of the vehicle flood protection bag illustrated in an unrolled, unfolded state;

FIG. 4 is a perspective view illustrating the vehicle flood protection bag with an open end of the bag held open and a vehicle positioned in front of the open end of the flood protection bag;

FIG. 5 is a perspective view illustrating the vehicle positioned within the flood protection bag;

FIG. 6 is a perspective view illustrating the open end of the flood protection bag including a securement device having a zipper as the zipper is zipped to seal the open end of the flood protection bag;

FIG. 6A is a perspective view illustrating the open end of the flood protection bag including a securement device having a series of grommets and a rope extending through the grommets to seal the open end of the flood protection bag;

FIG. 7 is a front end view of the vehicle flood protection bag with the vehicle shown in phantom with the open end closed with securement members;

FIG. 8 is a top view of the vehicle flood protection bag shown in FIG. 7 with cables secured between the securement members secured to front and rear ends of the vehicle flood protection bag; and

FIG. 8A is a top view of the vehicle flood protection bag shown in FIG. 7 with cables secured between grommets secured to corners of front and rear ends of the vehicle flood protection bag.

### DETAILED DESCRIPTION

Embodiments of the presently disclosed apparatus and method for vehicle flood prevention are now described in detail with reference to the drawings in which like reference numerals designate identical or corresponding elements in each of the several views. In the description that follows, terms such as front, rear, and similar directional terms are used simply for convenience of description and are not intended to limit the disclosure. In the following description, well-known functions or constructions are not described in detail to avoid obscuring the present disclosure in unnecessary detail.

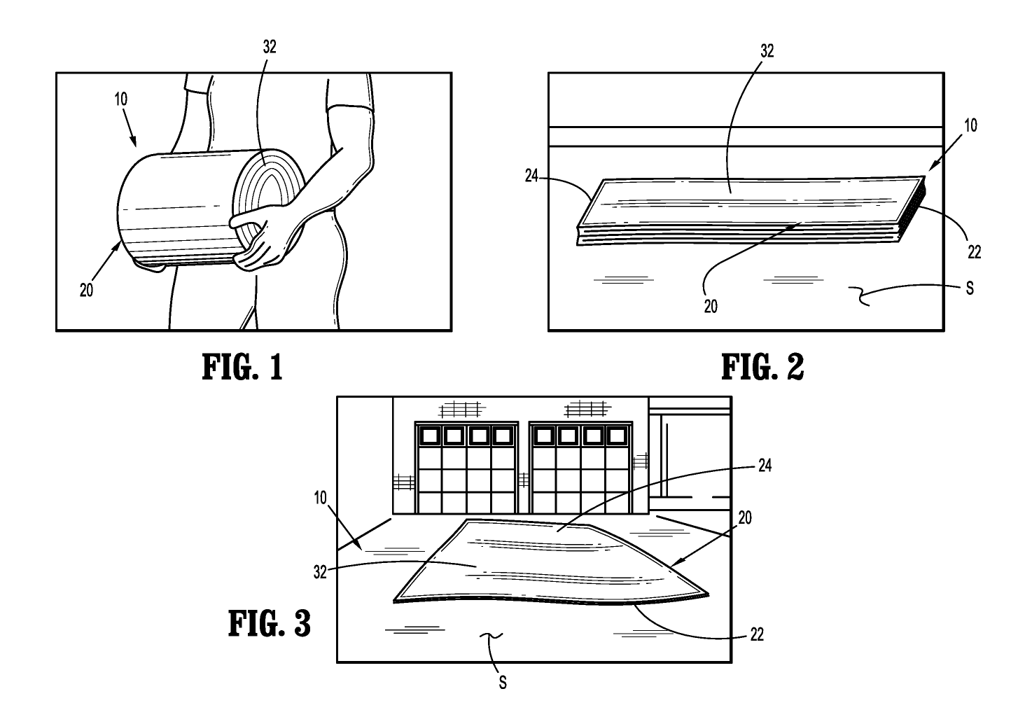

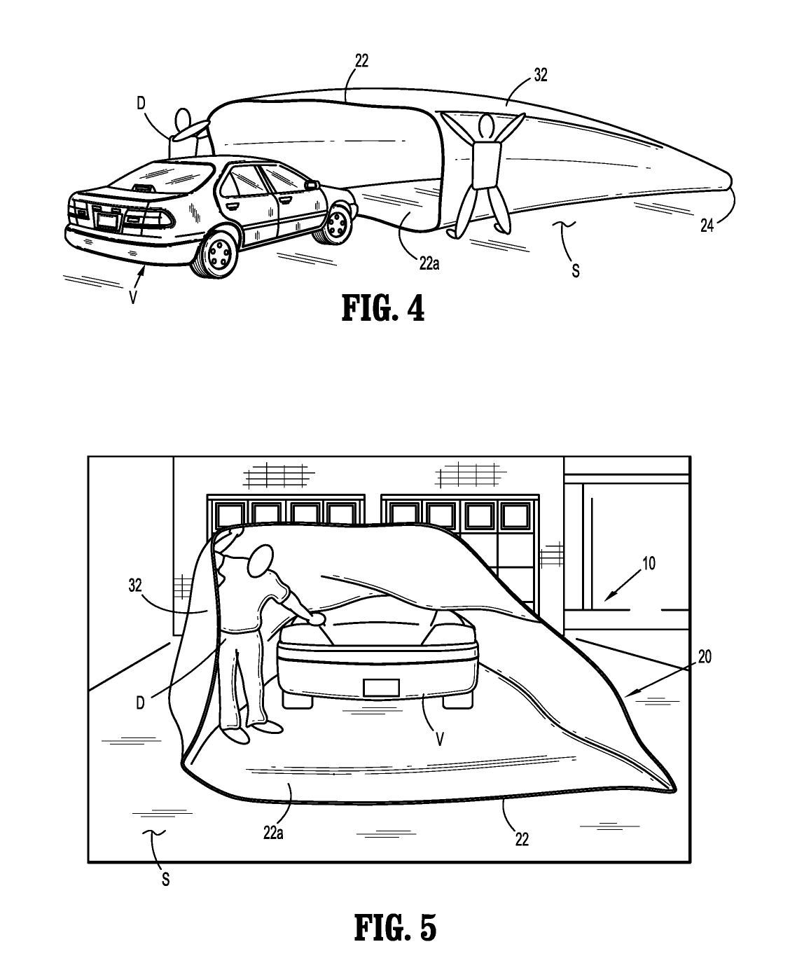

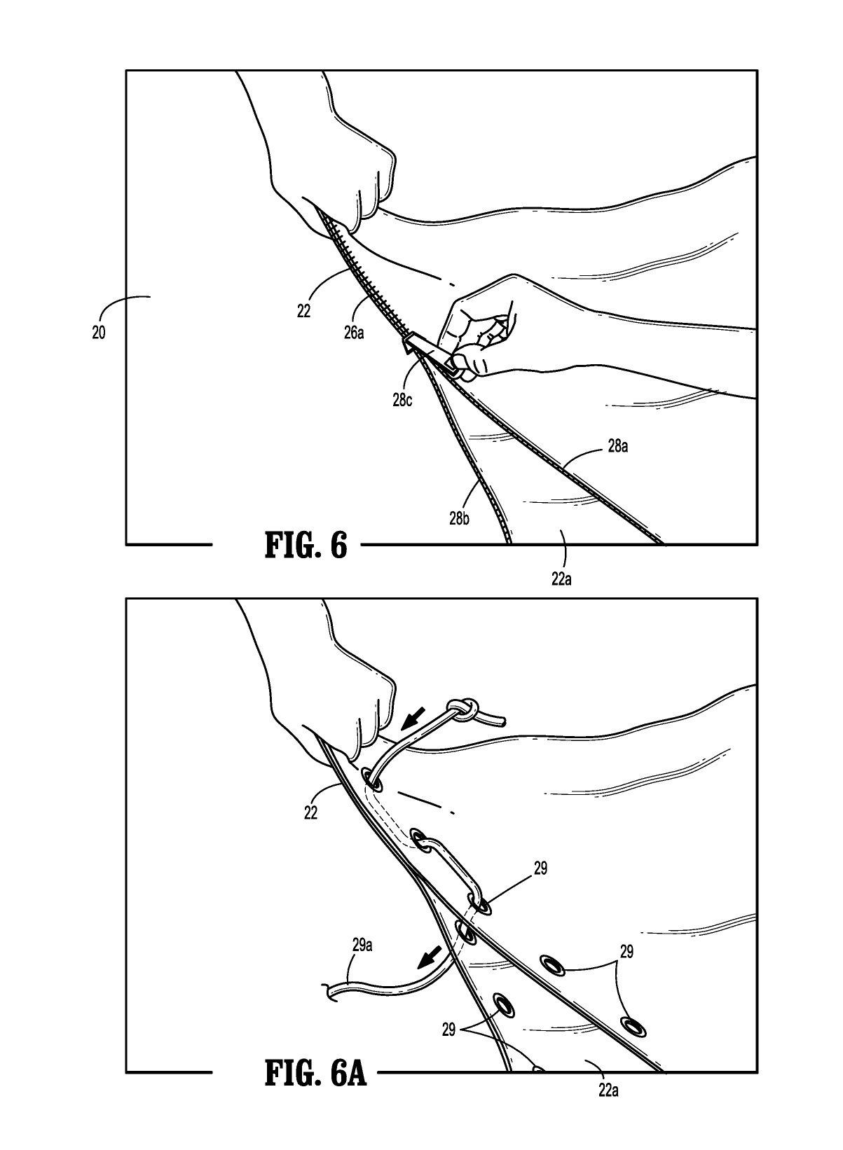

Referring to FIGS. 1-5, the presently disclosed vehicle flood prevention apparatus 10 includes a vehicle flood protection bag 20 having an open end 22 defining an opening 22a (FIG. 4), a closed end 24, and a securement device 26 configured to close and/or seal the open end 22 of the flood protection bag 20. In embodiments, the securement device 26 includes a zipper 26a (FIG. 6) which includes a first row of teeth 28a supported along one edge of the flood protection bag 20 defining the opening 22a, a second row of teeth 28b supported along an opposing edge of the flood protection bag 20 defining the opening 22a, and a slide 28c that is movable along the rows of teeth 28a and 28b to seal the opening 22a as is known in the art. Alternately, as shown in FIG. 6A, the securement device 26 may include a series of grommets 29 positioned along the edges of the open end 22 that are dimensioned to receive a rope, cable, cord, string or the like 29a to close the open end 22 of the flood protection bag 20.

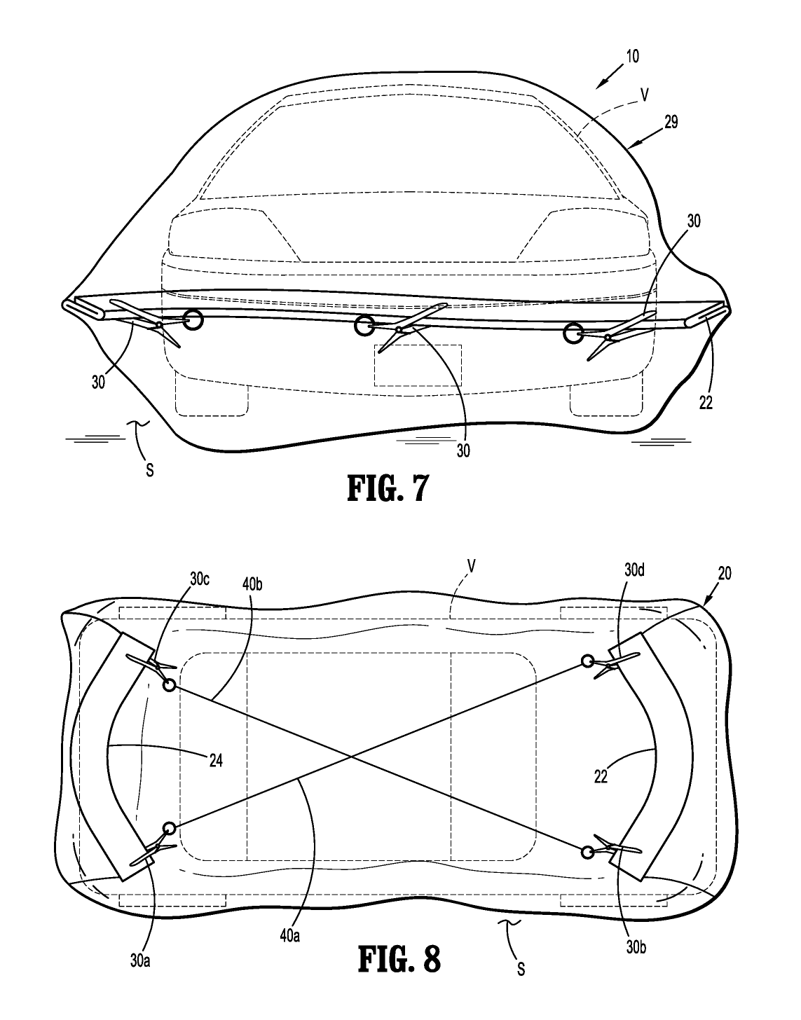

Referring to FIG. 7, in other embodiments of the presently described vehicle flood prevention apparatus 10, the securement device 26 includes a set of securement members 30 that are secured along the edges defining the opening 22a of the bag 20 to close the opening 22a. The securement members 30 cooperate to fully enclose a vehicle “V” within the flood protection bag 20 to prevent flood damage to the vehicle “V” as described in further detail below. The various components of vehicle flood prevention apparatus 10 are configured to facilitate the assembly, securement, disassembly, and storage of vehicle flood prevention system 10.

Referring again to FIGS. 1-5, the bag 20 may be formed from any suitable material(s) that is easily rolled, folded, and manipulated; strong; lightweight; tear-resistant; and water-resistant. Suitable materials include, for example, polyethylene and other polymeric materials. Further, bag 20 may be formed from a transparent or semi-transparent material, enabling a user to view the interior contents of bag 20 during assembly, use, and disassembly. Bag 20 defines an elongated body 32 including the open end 22 and the closed end 24. The closed end may be sealed in any suitable fashion so as to establish a water-tight seal. In particular, the closed end may be welded (or otherwise formed) so as to define a pair of opposed corners on either side of the closed end of bag 20. As will be detailed below, the opening 22a in the open end 22 of bag 20 is dimensioned to facilitate passage of a motor vehicle “V” into and out of bag 20. Although the drawings illustrate a car, the opening in the bag 20, and the bag itself, may be dimensioned to facilitate passage of a variety of vehicles or apparatus that may be damaged by flooding including cars, motorcycles, lawn mowers, tractors, trailers, campers or the like.

Referring again to FIG. 7, the securement members 30 are provided to maintain bag 20 in a closed state to prevent water from flowing into the bag 20 and contacting the vehicle “V” within the bag 20. In embodiments, the securement members 30 may be positioned along the opening 22a to secure the edges of the bag 20 defining the opening 22a together and close the opening 22a. Alternately, the open end 22 of the bag 22 can be closed and/or sealed using the zipper 28 (FIG. 6) or the grommets 29 (FIG. 6A). The securement members 30 may include tarp clips, clamps, or other suitable securement structures capable of secure attachment to bag 20 without penetrating or tearing bag 20.

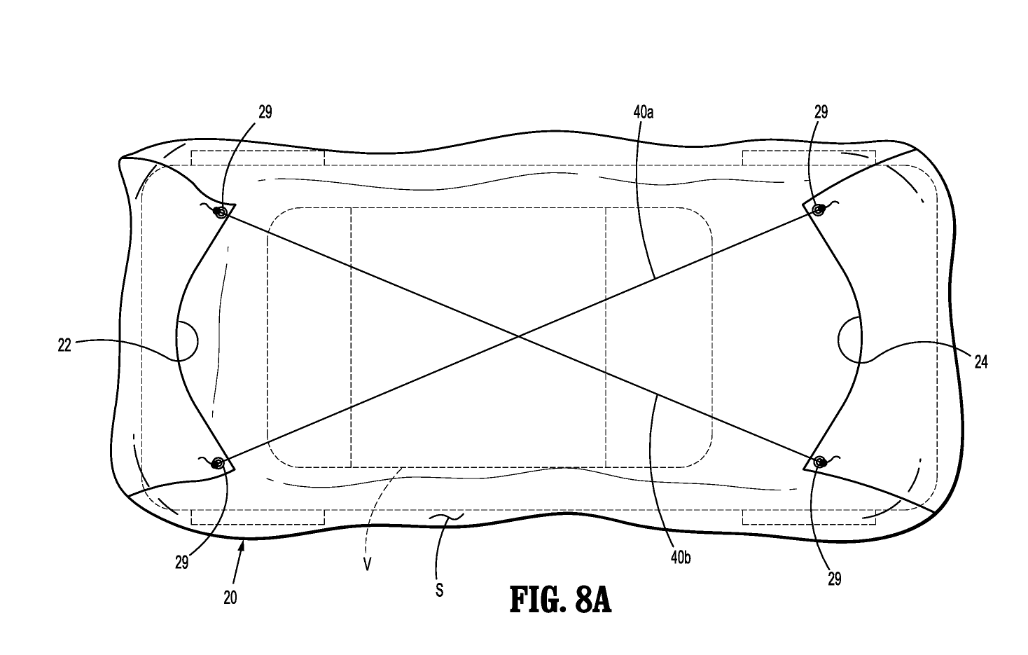

Referring to FIG. 8, cables 40a-b may be provided to interconnect two or more of the securement members 30 to securely retain bag 20 about the vehicle “V” and raise the height of the open end 22 of the bag 20. In embodiments, securement members 30a-d can be secured to the four corners of the bag 22 and attached to the cables 40a-b. More specifically, one cable 40a may be provided to interconnect the first and third securement members 30a and 30d, respectively, which are diagonally opposed to one another, while another cable 40b may be provided to interconnect the second and fourth securement members 30b and 30c which are likewise diagonally opposed to one another. Suitable cables 40a-b include ropes, elastic cords, etc. The cables 40a-b, when attached between opposing corners of the bag 20, form an X-shaped configuration and are dimensioned to pull the open end 22 of the bag 22 rearwardly onto the rear end of the vehicle “V” to raise the height of the open end 22 of the bag 20 and prevent water from flowing into the open end 22a of the bag 20 during a flood. The presently described configuration of cables 40a-b and securement members 30a-d may be used with a bag 20 having a zipper 28 (FIG. 6), grommets 29 (FIG. 6A), or additional securement clips 30 (FIG. 8) to close or seal the opening 22a of the bag 20.

Referring to FIG. 8A, in alternative embodiments, the cables 40a-b can be connected to grommets 29 included on each corner of the bag 20 to obviate the need for securement members 30. The cables 40a-b can be passed through the grommets 29 and be knotted at each end to prevent ends of the cables 40a-b from being pulled through the respective grommets 29. The cables 40a-b can be knotted at a selected position on the cable 40a-b to control the height of the open end 22 of the bag 20. Alternately, the cables 40a-b may include clips or hooks to engage the grommets 29.

Use of the presently disclosed vehicle flood prevention apparatus 10 is now described with reference to FIGS. 1-5. Various aspects and features of vehicle flood prevention apparatus 10 and the components thereof will become more apparent hereinbelow.

With initial reference to FIGS. 1-3, bag 20 is provided in a storage state wherein bag 20 is folded and/or rolled to facilitate storage and/or transport of bag 20. In preparation for use, bag 20 is positioned on a vehicle-accessible surface “S” such as a driveway, parking lot, etc. Once positioned on the surface “S”, the bag 20 is unrolled longitudinally as shown in FIG. 2 and, subsequently, unfolded laterally outwardly until the bag 20 lays flat on the surface “S”. In this position, the bag 20 is oriented such that the open end 22 of bag 20 is vehicle-accessible. In embodiments, the bag 20 can be stored in a variety of configurations and need not be rolled or folded.

Referring to FIGS. 4 and 5, with the bag 20 unrolled, unfolded, and positioned as mentioned above, the vehicle “V” may be prepped for insertion into the bag 20, if necessary. Preparation of the vehicle “V” may include, for example, folding the side mirrors of vehicle “V”, removing or stowing the antenna of the vehicle “V”, and/or otherwise stowing or removing any protruding components of the vehicle “V.” Once prepped, the vehicle “V” may be positioned within the bag 20 as described in further detail below.

Initially, the vehicle “V” is positioned adjacent the open end 22 of bag 20 and the opening 22a of the bag 20 is held in an open configuration. Although not shown, the opening 22a at the open end 22 of bag 20 may be held open via one or more persons and or objects such that the opening is sufficiently large to accept the vehicle “V.” In addition, the bag 20 may include a cuff or cuffs (not shown) formed about the opening 22a that removably receive support members or rods (not shown) to retain the opening 22a in an open configuration.

As shown in FIG. 5, when the opening 22a is in the open configuration, a driver “D” slowly advances the vehicle “V” into the open end 22 of bag 20 through the opening 22a until the vehicle “V” is fully disposed within the bag 20. In embodiments, the forward end of the vehicle “V” is advanced within the bag 20 until the front of the vehicle “V” is positioned adjacent the closed end 24 of the bag 20. As can be appreciated, forming the bag 20 of a transparent or semi-transparent bag 20 enhances the driver's ability to visually guide the vehicle “V” into the bag 20 to ensure proper positioning of the vehicle “V” within the bag 20.

Once the vehicle “V” is properly positioned within the bag 20 as detailed above, the driver “D” exits the vehicle “V.” Although care need be taken, it is envisioned that the bag 20 be suitably configured and dimensioned to allow the driver “D” to open the driver's door of the vehicle “V” with sufficient clearance to allow the driver “D” to exit and walk alongside vehicle “V” to exit the open end 22 of the bag 20.

Referring to FIG. 6, in embodiments in which the securement device 26 includes a zipper 26a, once the driver “D” has exited the vehicle “V” and the bag 20, the zipper 26a can be operated to close and seal the opening 22a in the open end 22 of the bag 20. In embodiments where grommets 29 (FIG. 6A) are provided, a rope 29a or the like can be inserted through the grommets 29 to close the open end of the bag 20. Finally, if securement members 30 are provided, the securement members can be secured to the open end 22 of the bag to close the opening 22A (FIG. 7).

If the bag 20 is larger than the vehicle “V” positioned within the bag 20, the open end 22 of the bag 20 may be rolled or folded towards the rear of the vehicle “V” to remove slack from the bag 20. By doing this, the height of the sealed opening 22a of the bag 22 is raised off the surface “S” to reduce any likelihood of water entering the bag 20 through the sealed opening 22a.

Turning to FIG. 8, once the vehicle “V” is fully encapsulated within the bag 20 and the open end 22 of the bag 20 is closed, securement members 30a-d, e.g., tarp clips, can be secured to the corners of the bag 20. In embodiments, the corners of the closed end 24 of the bag 20 may be folded to define a suitable thickness to facilitate attachment of the securement members 30a and 30c to the closed end 24 of the bag 20. The use of tarp clips is advantageous because tarp clips include a tightening screw that allows for secure engagement of the securement members 30a and 30c about the corners of bag 20, although other suitable securement members are also contemplated. Once securement members 30a and 30c are attached to the corners of the closed end 24 of bag 20, the cables 40a and 40b are looped through or otherwise attached to the securement members 30a and 30c, respectively. The cables 40a and 40b are then positioned over the hood and roof of the vehicle “V” in a crossed or “X”-shaped pattern, as shown in FIG. 8. Next, the open end of the bag 20 is rolled and/or folded longitudinally towards the vehicle “V” to reduce the slack in bag 20. Folding and/or rolling of the open end of bag 20, as can be appreciated, forms an opposed, folded corner on either side of the open end of bag 20. After the open end 22 of the bag 20 is folded or rolled, the securement members 30b and 30d are then secured to each of these corners as described above, and the adjacent ends of cables 40a and 40b are looped through or secured to securement members 30b and 30d, respectively. As shown in FIG. 8, the securement member 30a positioned adjacent the front, driver's side corner of the vehicle “V” is coupled to the securement member 30d positioned adjacent the rear, passenger's side corner of the vehicle “V” via a first cable 4040a, and the securement member 30c positioned adjacent the front, passenger's side corner of the vehicle “V” is coupled to the securement member 30b positioned adjacent the rear, driver's side corner of the vehicle “V” via a second cable 40b. Once this configuration has been achieved, the cables 40a and 40b are tightened and tied off to raise the height of the open end 22 of the bag 20 off of the surface “S”. As can be appreciated, the cables 40a and 40b define sufficient lengths to extend diagonally across the vehicle “V” with enough additional length to allow for tying-off of cables 40.

Alternately, as shown in FIG. 8A, the cables 40a-b can be connected to grommets 29 provided on each corner of the bag 20 to obviate the need for securement members 30. The cables 40a-b can be inserted through holes in the grommets 29 and knotted on each end to prevent the cables 40a-b from being pulled through the grommets 29. In addition, the position of the knots can be selected to control the length of the cables 40a-b and thus, the height of the open end 22 of the bag 20.

Referring still to FIGS. 8 and 8A, the vehicle flood prevention apparatus 10 is shown fully enclosing and securing the vehicle “V” within bag 20. As shown, the cables 40a-b cooperate with the securement members 30a-d (FIG. 8) and the grommets 29 (FIG. 8A) to substantially eliminate the slack from bag 20 while also securing bag 20 about the vehicle “V” in a water-tight manner. In addition, the cables 40a-b retain the open end 22 of the bag 20 in a raised state. It is envisioned that, using the above-described configuration and assembly, the vehicle flood prevention apparatus 10 is capable of maintaining a water-tight environment about the vehicle “V” in at least 2-3 feet of flooding. In order to ensure such, the cables 40a-b are sufficiently tightened to retain the corners of bag 20 at least 2-3 feet off the surface “S”.

When it is desired to remove the vehicle “V” from vehicle flood prevention system 10, the above-described methodology is followed in reverse. That is, cables 40a-b are separated from the securement members 30 or the grommets 29 and the open end of the bag 20 is opened by unzipping (FIG. 6), removing the rope 29a from the grommets 29 (FIG. 6A), or removing the securement members 30 from the open end 22 of the bag 20 (FIG. 7). Next, the driver “D” carefully enters bag 20, gets into the vehicle “V” and, with the assistance of one or more persons or objects maintaining the open end of bag 20 in an open configuration, backs the vehicle “V” out of bag 20. Once the vehicle “V” has been removed, the side mirrors, antenna, etc. of vehicle “V” maybe returned to their use positions.

After use, the bag 20 is folded inwardly from either side thereof to achieve the longitudinal position shown in FIG.2, and is then rolled up to once again achieve the storage state shown in FIG. 1. As an alternative, bag 20 may be configured as a disposable, single-use item.

The present disclosure should not be construed as limiting, but merely as exemplary of particular embodiments. It is to be understood, therefore, that the present disclosure is not limited to the precise embodiments described and/or shown, and that various other changes and modifications may be effected by one skilled in the art without departing from the scope or spirit of the present disclosure. Additionally, persons skilled in the art will appreciate that the features illustrated or described in connection with one embodiment may be combined with those of another and that such modifications and variations are also intended to be included within the scope of the present disclosure. Therefore, the present disclosure should not be construed as limiting, but merely as exemplifications of particular embodiments.

What is Claimed is:

1. A method of protecting a vehicle from flood damage comprising:
placing a flood protection bag having an open end and a closed end on a surface;
aligning the vehicle with the open end of the flood protection bag;
opening the open end of the flood protection bag to form an opening and to define a cavity within the flood protection bag;
advancing the vehicle through the opening and into the cavity of the flood protection bag; and
sealing the opening in the open end of the flood protection bag to enclose the vehicle within the flood protection bag.

2. The method of claim 1, wherein sealing the opening in the open end of the flood protection bag includes using a zipper positioned about the opening in the flood protection bag to seal the opening.

3. The method of claim 1, wherein sealing the opening in the open end of the flood protection bag includes attaching securement members to edges of the flood protection bag defining the opening.

4. The method of claim 1, further including attaching securement members to corners of the open and closed ends of the flood protection bag and connecting first and second cables diagonally between the securement members on the closed end of the flood protection bag and the securement members on the open end of the flood protection bag to raise a height of the open end of the flood protection bag.

5. The method of claim 4, further including folding or rolling the open end of the flood protection bag to remove slack from the flood protection bag prior to attaching the securement members to the corners of the open end of the flood protection bag.

6. The method of claim 1, further including prepping the vehicle prior to advancing the vehicle into the cavity of the flood protection bag.

7. The method of claim 1, wherein prepping the vehicle includes removing an antenna from the vehicle.

8. The method of claim 1, wherein the flood protection bag is dimensioned to allow a driver to exit the vehicle and the flood protection bag when the vehicle is positioned within the flood protection bag.

9. The method of claim 1, further including folding or rolling the open end of the flood protection bag to reduce slack in the flood protection bag.

10. The method of claim 1, wherein sealing the open end of the flood protection bag includes inserting a rope through grommets positioned along edges of the flood protection bag defining the opening.

11. The method of claim 1, further including connecting first and second cables diagonally between grommets positioned on corners of the open and closed ends of the flood protection bag to raise a height of the open end of the flood protection bag.
